(19) United States
(12) Patent Application Publication
(10) Pub. No.: US 2020/0034472 A1
(43) Pub. Date: Jan. 30, 2020

(54) ASYNCHRONOUS CACHE COHERENCY FOR MVCC BASED DATABASE SYSTEMS

(71) Applicant: Futurewei Technologies, Inc., Plano, TX (US)

(72) Inventors: Le Cai, Cupertino, CA (US); Jianjun Chen, Cupertino, CA (US); Yang Sun, Palo Alto, CA (US); Xiaolin Du, Cupertino, CA (US); Jun Chen, Santa Clara, CA (US); Yu Chen, San Jose, CA (US); Chunfeng Pei, San Jose, CA (US)

(21) Appl. No.: 16/047,458

(22) Filed: Jul. 27, 2018

(51) Int. Cl. G06F 17/30

(52) U.S. Cl. CPC G06F 17/30578; G06F 17/30377; G06F 17/30339

(57) ABSTRACT

A database system comprises a persistent storage device, a log node including a memory and a processor, and a plurality of database nodes. A database node includes a cache memory configured to store a database instance, and a processor configured to initiate a database transaction by sending a snapshot request to the log node, the snapshot request including a list of pages that were either replaced or newly loaded in the cache memory. The log node processor is configured to send a snapshot response to the database node, wherein the snapshot response includes a snapshot of the database and a list of changed pages of the database instances. The database node processor is configured to update the status of the pages in cached memory according to the snapshot response and perform the database transaction.

### FIELD OF THE INVENTION

The present disclosure is related to distributed database systems in which multiple database instances access a shared memory, and in particular to maintaining correctness of the data among the multiple database instances.

### BACKGROUND

A distributed database refers to a database accessed by multiple entities in a computing system (e.g., a cloud database). In a distributed database system, multiple instances or versions of the database are maintained by separate entities or masters. The multiple database instances are allowed to access shared data. This allows the database to still be available to other instances when any one database instance fails. When multiple database instances are given access to the shared data, the instances need to maintain cache (or buffer pool) coherency, otherwise obsolete data may be read and cause data inconsistency among the multiple data base versions.

In a conventional distributed database system, messaging among the database instances is used to synchronize the databases and maintain database coherency. When a page is loaded into a local buffer pool of one database instance, information related to the caching is broadcast to all the other database instances in a global communication. When a page is modified, another global communication is broadcast to invalidate the copies of the page in the other database instances. The broadcasting of the coherency information can introduce considerable network overhead that can cause bottlenecks in accesses to the database. This network overhead can reduce the bandwidth of access to the database.

### SUMMARY

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, there is provided a data base system comprising a persistent storage device; a log node including a memory and a processor; and a plurality of database nodes. A database node includes a cache memory configured to store a database instance, and a processor configured to initiate a database transaction by sending a snapshot request to the log node, the snapshot request including a list of pages that were either replaced or newly loaded in the cache memory. The log node processor is configured to send a snapshot response to the database node, wherein the snapshot response includes a snapshot of the database and a list of changed pages of the database instances. The database node processor is configured to update the status of the pages in cached memory according to the snapshot response and perform the database transaction.

Optionally, in the preceding aspect, another implementation of the aspect provides a database node processor configured to: change a page status to semi-valid and assigning a valid log snapshot number (LSN) to the page when loading the page from the persistent storage device; and include a list of pages with the semi-valid page status and the valid LSN of the pages in the snapshot request. The implementation also optionally includes log node processor is configured to identify a page as invalid for the database node using a comparison of the page valid LSN to a latest LSN for the page; and include identified invalid pages in the snapshot response.

Optionally, in the preceding aspect, another implementation of the aspect provides a log node processor configured to send the valid LSN in the snapshot response.

Optionally, in any of the preceding aspects, another implementation of the aspect provides a database node processor configured to: change a page status to semi-valid when loading the page from the persistent storage device; change a page status from semi-valid to invalid if the page is indicated as changed in the list of changed pages; and change a page status from semi-valid to valid if the page is a newly loaded page and the page is not indicated as changed in the changed page list.

Optionally, in any of the preceding aspects, another implementation of the aspect provides a database node processor is configured to: change a page status from valid or semi-valid to invalid if the page is indicated as changed in the list of changed pages; and change a page status from invalid to semi-valid when loading the page from the persistent storage device.

Optionally, in any of the preceding aspects, another implementation of the aspect provides a log node processor configured to: send a record of executed database transactions from the log node to a persistent storage device; and send the snapshot response when records of database transactions executed prior to the initiated database transaction were sent to the persistent storage device by the log node.

Optionally, in the preceding aspect, another implementation of the aspect provides a persistent storage device configured to generate the database snapshot using the record of executed database transactions.

Optionally, in any of the preceding aspects, another implementation of the aspect provides log node memory configured to store a hash table for cached pages of the database node; and update the hash table in response to the snapshot request.

According to another aspect of the present disclosure, there is provided a computer-implemented method of database coherency in a system containing multiple database instances. The method comprises initiating a database transaction by sending a snapshot request from a database node to a log node, the snapshot request including a list of pages in a cache memory of the database node that were either replaced or newly loaded; receiving a snapshot response at the database node from the log node, wherein the snapshot response includes a snapshot of the database and a list of changed pages of the database instances; and updating the status of the pages in cached memory of the database node according to the snapshot response and performing the database transaction.

Optionally, in the preceding aspect, another implementation of the aspect provides changing, in the database node, a page status to semi-valid and assigning a valid log snapshot number (LSN) to the page when the page is loaded from persistent storage; including a list of pages with the semi-valid page status and the valid LSN of the pages in the snapshot request; and receiving, at the database node, identified invalid pages and the valid LSN in the snapshot response.

Optionally, in the preceding aspect, another implementation of the aspect provides identifying, by the log node, a page as invalid for the database node using a comparison of the page valid LSN to a latest LSN for the page.

Optionally, in any of the preceding aspects, another implementation of the aspect provides changing a page status to semi-valid when the page is loaded from persistent storage; changing a page status from semi-valid to invalid if the page is indicated as changed in the list of changed pages; and changing a page status from semi-valid to valid if the page is a newly loaded page in the database node and the page is not indicated as changed in the changed page list.

Optionally, in any of the preceding aspects, another implementation of the aspect provides changing a page status from valid or semi-valid to invalid if the page is indicated as changed in the list of changed pages; and changing a page status from invalid to semi-valid when the page is loaded from persistent storage.

Optionally, in any of the preceding aspects, another implementation of the aspect provides sending a record of database transactions committed prior to the initiated database transaction from the log node to a persistent storage device; and sending the snapshot response when the record is sent.

Optionally, in any of the preceding aspects, another implementation of the aspect provides updating, by the log node, a hash table for cached pages of the database node in response to the snapshot request.

Optionally, in any of the preceding aspects, another implementation of the aspect provides storing a database instance of the multiple database instances in the cache memory of the database node, and wherein initiating the database transaction includes a processor of the database node initiating the database transaction.

According to another aspect of the present disclosure, there is provided a log node of a database system. The log node comprises a memory storage comprising instructions; and one or more processors in communication with the memory. The one or more processors execute the instructions to: receive a snapshot request from a database node of the database system, the snapshot request including a list of pages either replaced or newly loaded in cache memory of the database node; and send a snapshot response to the database node, wherein the snapshot response includes a snapshot of the database and a list of changed pages of the database instances.

Optionally, in the preceding aspect, another implementation of the aspect provides one or more processors that execute instructions to assign a valid log snapshot number (LSN) to the database transaction; identify a page as invalid for the database node using a comparison of the page valid LSN to a latest LSN for the page; and include identified invalid pages in the snapshot response.

Optionally, in any of the preceding aspects, another implementation of the aspect provides one or more processors that execute instructions to send a record of executed database transactions from the log node to a persistent storage device; and send the snapshot response when records of database transactions executed prior to the initiated database transaction were sent to the persistent storage device by the log node.

Optionally, in any of the preceding aspects, another implementation of the aspect provides one or more processors that execute instructions to store a hash table for cached pages of the database node; and update the hash table in response to the snapshot request.

### BRIEF DESCRIPTION OF THE DRAWINGS

FIG. 1 is a block diagram of a distributed database system according to an example embodiment.

FIG. 2 is a block diagram of another distributed database system according to an example embodiment.

FIG. 3 is a state diagram of an asynchronous cache coherence protocol according to an example embodiment.

FIG. 4 shows a timeline of database transactions and a semi-valid page list for a distributed database system according to an example embodiment.

FIG. 5 is a state diagram of the status of pages cached by a database node of a distributed database system according to an example embodiment.

FIG. 6 shows an example of generating an invalid map for database nodes of a distributed database system according to an example embodiment.

FIG. 7 is a flow diagram of database transaction processing by a distributed database system according to an example embodiment.

FIG. 8 is a block diagram illustrating circuitry for clients, servers, cloud based resources for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

In a conventional distributed database system, messaging among the multiple database instances is used to synchronize the databases and maintain database coherency. The coherency of the database is managed centrally. Coherence across the multiple database nodes is maintained globally using a global pool buffer. The central database management can include global messaging to perform global locking operations and global invalidation operations for example.

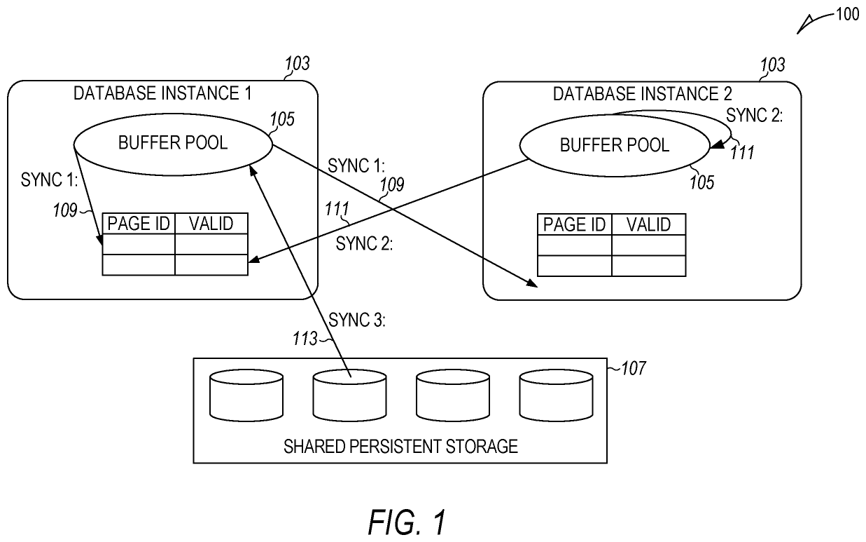

FIG. 1 is a block diagram of a distributed database system 100. The system includes database instance 1 and database instance 2. Each database instance can reside on a database node 103 or database master. Each database node can access shared data in persistent storage 107 that can include one or more servers. Only two database instances are shown in FIG. 1 for simplicity. A distributed database system may include tens or hundreds of database instances. Each database instance includes a buffer pool 105 that can be a cached memory that holds a copy or instance of the shared data. When multiple database instances access shared data, they need to maintain cache (or buffer pool) coherency, otherwise they may read obsolete data and cause data inconsistency.

FIG. 1 shows three cross-network operations that are used to maintain cache coherency among the database instances. The operations are synchronized among all of the database instances and impact all of the database instances. Sync operation 1 (SYNC 1) 109 is a register page operation. When a page is loaded into local buffer pool, the information is broadcasted to all the other database instances. For SYNC 1, FIG. 1 shows the page registration being placed in the local buffer pool of database instance 1 and broadcast to database instance 2. Alternatively, the loading is registered in a centralized database component, such as global buffer pool. One of the copies of the buffer pool can be designated as the global buffer pool. When a page is read by a database node, it is registered in global buffer pool.

Sync operation 2 (SYNC 2) 111 is an invalidate page operation. When a database transaction modifies a page, the database transaction needs to invalidate the database copies of the page in the buffer pools of the other database nodes before committing. “Committing” refers to the point in a transaction of updating of the data in the persistent storage where the data is made visible to the other database nodes. For SYNC 2, FIG. 1, shows a page being changed in database instance 2 and the page being invalidated in database instance 1. In the global pool example, if there is another node interested in the same page registered in the global pool, then a global lock is acquired for this page. The page is loaded from persistent storage and cached in local buffer pool. When another member accesses the page, the two members need to negotiate the status of global lock. If one member updates the page, before it commits the updating transaction, it invalidates the copy in the other member's local buffer pool.

Sync operation 3 (SYNC 3) 113 is a reload page operation. When a database node attempts to read an invalid page, a valid version of the page is loaded from other database nodes or from the persistent storage. For SYNC 3, FIG. 1 shows a page being loaded into database instance 1.

All of three of the SYNC operations involve network communication and can introduce considerable network overhead when executing a database transaction. For example, sync operation 2 can be the critical path for a database transaction by directly blocking a commit process. Overhead transactions such as theses can become the main bottlenecks to increasing throughput for a multi-master database system. The present inventors have recognized a need for improved communication in distributed database systems.

An improved approach to implement database coherency across the database nodes is to perform operations such as page registration and page invalidation asynchronously instead of as operations synchronized among all of the nodes of the database. The cache coherency information is communicated asynchronously and is delayed until it is needed for read consistency and cache coherence. Instead of the SYNC 1 page registration operation, cached pages are registered incrementally and on demand, without using global operations that can hinder higher system throughput. Instead of the SYNC 2 invalidation operation, cache invalidation operations are delayed until needed. The result is that the overhead associated with page registration is removed and page invalidation is removed from the critical path for database transactions. For the SYNC 3 page reload operation, the latest versions of pages are retrieved from persistent storage in an on-demand basis.

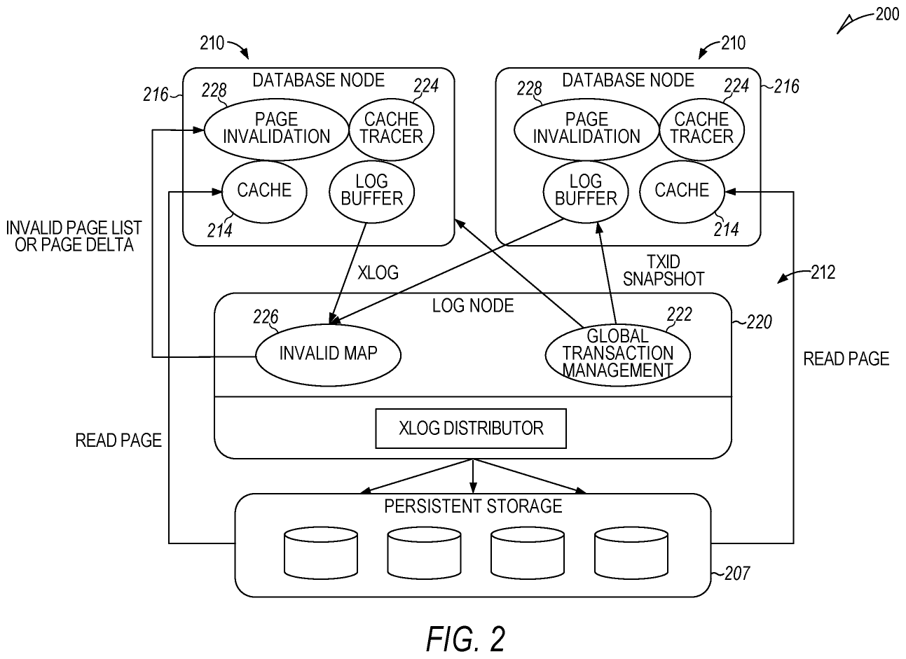

FIG. 2 is a block diagram of another distributed database system 200. The system supports computation-storage separation. The database system 200 includes one or more persistent storage devices 207 (e.g., servers), multiple database nodes 210, and a log node 212. A database node or log node can include one or more processors and a memory. The memory of a database node 210 includes a cache memory 214 to store a database instance. The database nodes receive queries (e.g., a structured query language or SQL queries) or one or more of update, insert, delete, and create operations from users. The data for the operations is provided from the cache memories of the database nodes, or from the persistent storage if the data is missed from the cache memories. Information needed for cache coherency is communicated between the database nodes 210 and the log node 212 asynchronously.

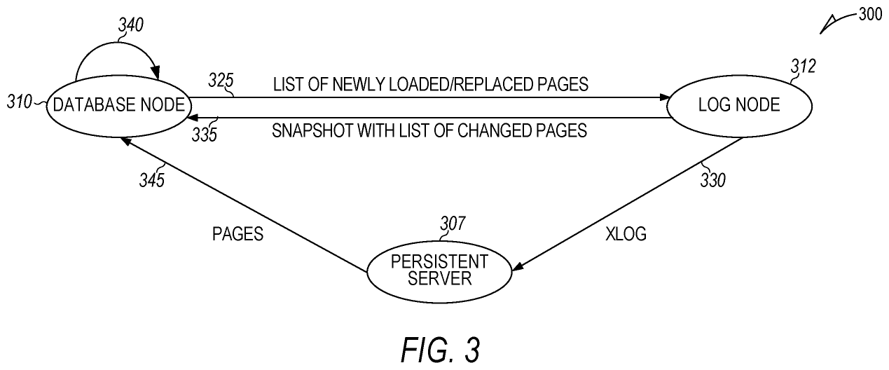

FIG. 3 is a state diagram 300 of an asynchronous cache coherence protocol. At 325, a database transaction is initiated by a processor of a database node 310 by sending a snapshot request to the log node 312. The snapshot request includes a list of pages in the cache memory of the database node that were either replaced or newly loaded.

At 330, the log node 312 sends log records (Xlog) to persistent storage 307. The log records include database transactions by all of the database nodes that were committed before the current new database transaction. When a database transaction modifies a page, it creates a log record. The log records are sent to the log node 312 when the database transaction commits The log node 312 takes the log records and sends them to the persistent storage 307 where new versions of the data are created. The persistent storage 307 receives the log records from the log node 312 and stores them. The persistent storage 307 generates the data of database by replaying the log records and read page requests made to the persistent storage from the database nodes.

At 335, the log node 312 sends a snapshot response to the database node 310. The snapshot response includes the snapshot of the database. The snapshot is determined by the log records flushed to persistent storage. For example, if a total of 1,024,000 (1024K) log records are flushed to the persistent storage, the snapshot response will include a 1024K snapshot. The snapshot response also includes a list of changed pages of the database instances. At 340, a processor of the database node 310 updates the status of the pages in the cached memory of the database node 310 according to the snapshot response and performs the database transaction. The operations of the database transaction are only performed on this returned snapshot. Any concurrent changes by other database nodes are invisible to this transaction.

At 345, when a processor of the database node processor 310 needs to access data of a page indicated as invalid in the snapshot response, the database node 310 retrieves the version of the page in persistent storage 307. The persistent storage 307 applies the received log records and will return the latest version of the page.

Returning to FIG. 2, the database nodes can include a cache tracer component 224. The cache tracer component 224 can include software or firmware executed by the database node processor 216. The cache tracer component 224 can be used by a database node to trace or track the latest pages loaded from persistent storage servers and the replaced pages in the cache memory 214. For each database transaction, the cache tracer prepares two lists. One is a list of newly loaded pages and the other is a list of pages replaced since the last snapshot was acquired.

The log node 212 can include a global transaction management (GTM) component. The GTM component 222 can include software or firmware executed by the log node processor 220. The GTM component generates an ascending log snapshot number (LSN). The LSN is used in maintaining the snapshots. The database nodes can acquire a snapshot as a list of active transactions from the log node when the database transaction is initiated. The log node 212 may also use the LSNs to maintain a hash table to track pages cached in each of the database nodes.

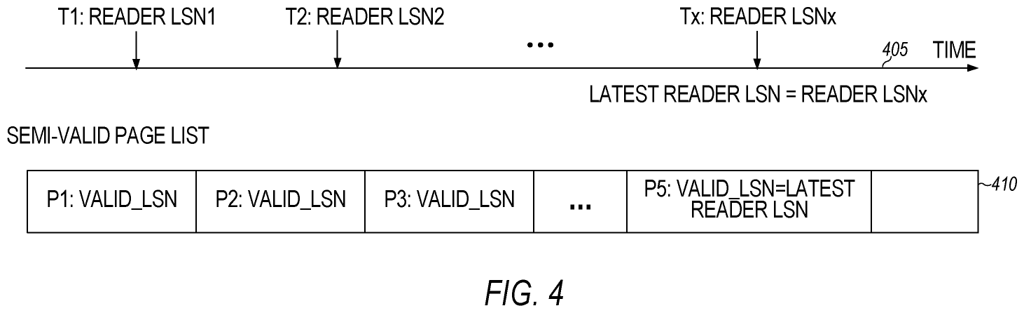

FIG. 4 shows a timeline 405 of database transactions or reader transactions T1, T2 . . . Tx. The log node assigns a Reader LSN to each of the transactions (Reader LSN1, Reader LSN2 . . . Reader LSNx). In certain embodiments, the Reader LSNs include a timestamp.

The log node 212 can include an invalid map component 226. The invalid map component 226 can be used by the log node to generate an invalid map as the list of invalid pages for a specific database node. Invalid pages are those pages cached by the database node that have been changed by the other database nodes. The invalid map is returned to the specific database node after those changes have been committed and the log records of those changes have been sent to persistent storage 207. The database nodes can include a page invalidation component 228. The page invalidation component 228 can be used by a database node to invalidate the cached pages according to the invalid map. When the database node 210 wants to access an invalid page, the corresponding page in persistent storage 207 is loaded.

Pages cached in a database node can be valid, semi-valid, or invalid. A page is valid if it was loaded by the database from persistent storage and it is not listed in an invalid map subsequently received from the log node. A page is marked as invalid if is included in an invalid map. A page is marked as semi-valid when it is first loaded into cache memory.

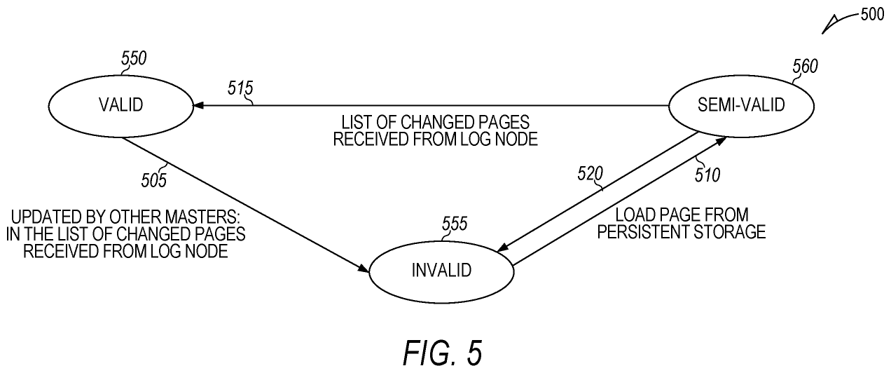

FIG. 5 is a state diagram 500 of the status of pages cached by a database node of the database system. At 505, a valid page 550 turns invalid when another database node modifies the page and the modification commits to the log node. Information of the changed page is included in the invalid map received from the log node. At 510, an invalid page 555 turns semi-valid when the database node tries to access the invalid page and the database node loads the corresponding page from persistent storage due to the invalid status. At 515, a semi-valid page 560 can turn valid, and at 520 a semi-valid page can turn invalid.

The database node keeps track of whether the semi-valid page turns valid or invalid using the lists of changed pages (invalid maps) received from the log node. When a database node receives a snapshot response from the log node it includes the invalid map or list of changed pages. If a semi-valid page is included in the list, then a change to the page occurred recently and the page status changes to invalid. If the semi-valid page is included in the list of newly loaded pages of the database node and is not in the returned changed page list, then the page status changes to valid. Pages that turn valid or invalid are removed the semi-valid list.

The cache tracer component 224 of a database node maintains a semi-valid page list. FIG. 4 shows an example of a semi-valid page list 410. The semi-valid page list is comprised of list pairs that include a page number and a Valid LSN (Px: Valid LSN). This Valid LSN can be the same or different for the list pairs and is the latest Reader LSN when the database node starts to load the corresponding page. This means the loaded page is valid for all snapshots having an LSN less than this Valid LSN. This is guaranteed in the asynchronous cache coherence protocol by having the log node check that all committed log records are already sent or flushed to persistent storage when any snapshot (and its Reader LSN) is returned to a database node.

When a database transaction is initiated by a database node, it uses the semi-valid page list to build the list of newly loaded pages to include in the snapshot request. Only those newly loaded pages are included in the list. Any pages picked by a previous transaction are excluded from the list of newly loaded pages.

In the case of a network failure, snapshot request messages or snapshot response messages may be lost and resent, or pages about to turn valid may be reloaded and flagged as semi-valid. The Valid LSNs of the pages in the semi-valid page list can be compared by the database node with the Reader LSN of the active database transaction. If the Valid LSNs of the semi-valid list are greater than or equal to the Reader LSN, then the page remains semi-valid. If the Valid LSN is less than the Reader LSN, the page in the list is invalid.

To generate an invalid map, the invalid map component 226 of the log node 212 maintains a hash table for cached pages of each database node. The invalid map component 226 may also maintain a separate list of pages changed for each database node since the last Reader LSN for each database node. Pages updated by the other database nodes are appended to this separate list of page. It should be noted that one page may have multiple entries in the list due to multiple updates occurring at different times.

When a database node sends a snapshot request with the newly loaded pages, the list of newly loaded pages includes the Valid LSNs of those pages. When the log node receives the list, the log node first inserts those pages into the hash table for the database node, and then generates the Reader LSN for the database transaction. The invalid map component 226 determines those pages that have a Valid LSN less than the Reader LSN and adds them to the invalid map. Those pages that have a Valid LSN greater than or equal to the Reader LSN become valid.

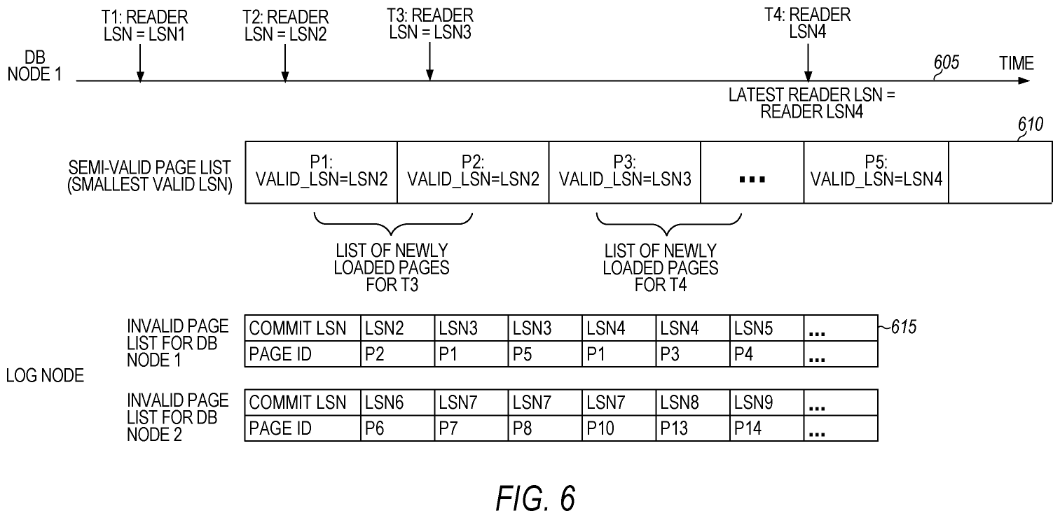

FIG. 6 shows an example of generating an invalid map for database nodes. A timeline 605 of database transactions (T1, T2, T3, T4) is shown for database (DB) node 1. For database transaction T3, the Reader LSN is LSN3 and the list of newly loaded pages for DB 1 for T3 is {(P1, LSN2), (P2, LSN2)}. FIG. 6 also shows the semi-valid page list 610 of DB node 1. The elements of the semi-valid page list 610 include a page identifier (page ID P1, P2, P3 . . . P5) and a smallest Valid LSN for the corresponding page.

FIG. 6 also shows invalid page lists maintained by the log node for DB node 1 and DB node 2. The invalid page list 615 for DB node 1 is a list of pages cached by DB node 1 that were recently changed. The elements of the list include a page ID and a Commit LSN. The invalid map component 226 compares the semi-valid list and the invalid page list to identify which semi-valid pages are changed between the Valid LSN and the Reader LSN.

For page P2, because the Valid LSN of the semi-valid page list is greater than or equal to the Commit LSN in the invalid page list, the version of P2 cached in DB node 1 is valid. The other versions of P2 in the other DB nodes will not be visible to DB node 1. For page P1, because the Valid LSN of the semi-valid page list 610 is less than the Commit LSN of the invalid page list 615, the version of P1 cached in DB node 1 may be old and the version of P1 in DB node 1 is invalid.

Reader LSNs are used by the log node 212 to determine which list elements in the invalid page list should be checked. For example, because the Reader LSN for T3 is LSN3, only first three elements of the invalid page list P2, P1, and P5 are checked. The elements with a Valid LSN greater than LSN3 (e.g., LSN4 and LSN5) are not checked because the page changes are invisible to transaction T3.

When database nodes send the list of newly loaded pages to the log node in the snapshot request, the database nodes can include a smallest Valid LSN for the newly loaded pages. This Valid LSN can be used by the log node to remove items in the invalid page lists. If a database node finds its last Reader LSN is too old (e.g., because no database transactions occur in the database node), it can send a list of newly loaded pages with an unrealistically large Valid LSN. This way, the list of changed pages maintained in the log node for the database node can be proactively truncated by the database node. This request can be issued periodically to avoid the situation in which some real snapshot requests are lost and the corresponding newly loaded page lists are not processed to determine the invalid page map. If the list of changed pages is not truncated, the loss of the list of newly loaded page lists will result in false invalid pages that trigger future accesses that will always result in loading data from persistent storage.

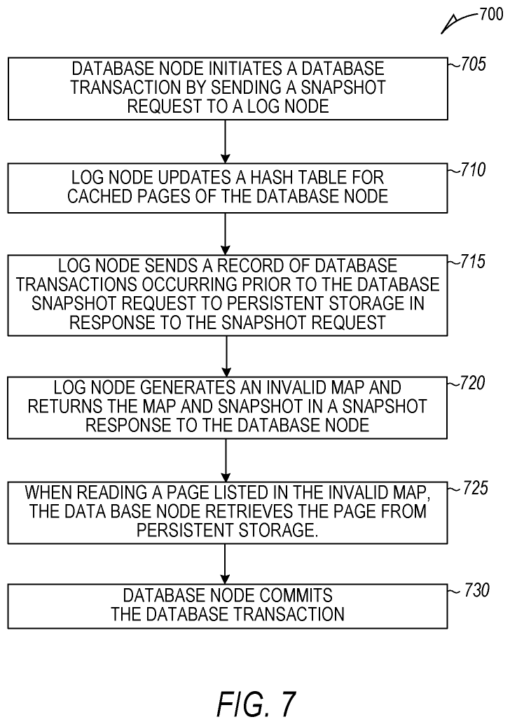

FIG. 7 is a flow diagram 700 of the database transaction processing by the distributed database system of FIG. 2. At 705, a database transaction is initiated by a database node sending a snapshot request to the log node. The snapshot request is to obtain a database snapshot and a Reader LSN. The request can include two lists: a list of pages newly added by the requesting database node, and a list of pages replaced by the requesting database node.

At 710, the log node updates a hash table for cached pages of each database node. At 715, the log node sends a record of database transactions occurring prior to the database snapshot request to persistent storage. The log node checks that log records of previously committed transactions have been flushed or sent to persistent storage servers before returning the snapshot and the invalid page list to the requesting database nodes.

At 720, the log node generates an invalid map (invalid page list) and returns the invalid map with the snapshot to the database node. At 725, when the database node reads a page indicated to be invalid in the invalid map, the database node retrieves the page from persistent storage. At 730, the database node commits the database transaction. When committing, log records are sent to the log node.

In a multi-version database system, a transaction acquires a snapshot of a database and the operations of the transaction only work on the acquired snapshot. Any concurrent changes happening within the system are invisible to this transaction. The transaction accesses cached data at a database node or data from persistent storage. The asynchronous cache coherency protocol guarantees accessed data is in the snapshot of the transaction or a newer snapshot.

All pages in a cache are the latest version or a snapshot version. No committed change happens to the cached pages before the transaction acquires the snapshot. Some cached pages become invalid, but no page in the cache is loaded by another transaction before the snapshot is acquired. Those pages in cache are marked as invalid either by the transaction or by another transactions having an older snapshot. New versions of the cached pages are acquired from persistent storage if those pages are accessed by the transaction.

If pages in cache memory of a first database node are loaded by other database nodes before the transaction of the first database node, those loaded pages are in the newly loaded list of the other database nodes. The returned invalid map of changed pages can verify if the pages are valid or invalid. If invalid the first database node retrieves the pages from persistent storage. The persistent storage always returns the latest version of a page because the log node flushes or sends log records of the previously committed transactions before returning the snapshot to the database node.

Some pages in cache of the first database node can be loaded by other database nodes during the transaction of the first database node. If those pages are loaded between the time of the sending of the snapshot request by the database node and the returning of snapshot response by the log node, the pages are semi-valid and they are retrieved from persistent storage if the Valid LSN of the pages is smaller (older) than the Reader LSN of the snapshot.

If those pages are loaded after the time of the sending of the snapshot response (that includes the snapshot and the Reader LSN), the pages are semi-valid but the Valid LSN of the pages is greater than or equal to (not older than) the Reader LSN of the snapshot, and the pages can be used in the transaction. Thus, the asynchronous cache coherency protocol guarantees the correct data is accessed in database transactions.

It can be seen that cache coherency is maintained across the multi-master database nodes. The asynchronous cache coherency protocol delays cache invalidation operation until needed, registers cached pages incrementally and on-demand without global locking, and retrieves the latest versions of pages from persistent storage on-demand In comparison to conventional synchronized approaches to coherency, the asynchronous cache coherency approach reduces the network interaction needed for transaction committing and data access. This reduces network bottlenecks and can increase throughput.

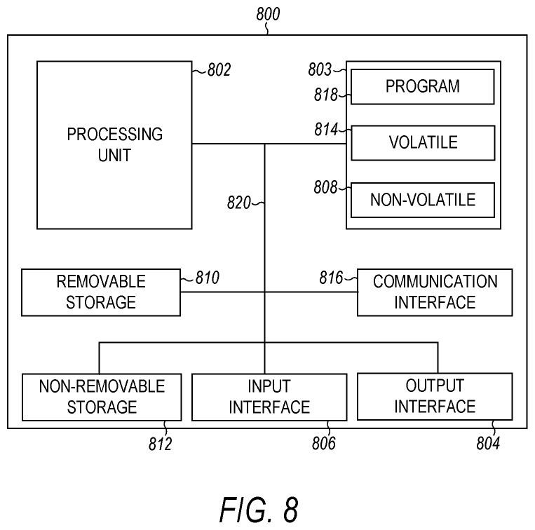

FIG. 8 is a block diagram illustrating circuitry for one or both of a database node and a log node for performing methods according to example embodiments. All components need not be used in various embodiments. For example, a database node and a log node may each use a different set of components.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, or other computing device including the same or similar elements as illustrated and described with regard to FIG. 8. Devices, such as smartphones, tablets, and smartwatches, are generally collectively referred to as mobile devices or user equipment. Further, although the various data storage elements are illustrated as part of the computer 800, the storage may also or alternatively include cloud-based storage accessible via a network, such as the Internet or server based storage.

Memory 803 may include volatile memory 814 and non-volatile memory 808. Cache memory may be implemented using one or both of the volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input 806, output 804, and a communication connection 816. Output 804 may include a display device, such as a touchscreen, that also may serve as an input device. The input 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks. According to one embodiment, the various components of computer 800 are connected with a system bus 820.

Computer-readable instructions stored on a computer-readable medium are executable by the processing unit 802 of the computer 800, such as program 818. The program 818 in some embodiments comprises software that, when executed by the processing unit 802, performs coherency operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage such as a storage area network (SAN). Computer program 818 may be used to cause processing unit 802 to perform one or more of the algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A database system comprising:
a persistent storage device;
a log node including a memory and a processor; and
a plurality of database nodes, wherein a database node includes a cache memory configured to store a database instance, and a processor configured to initiate a database transaction by sending a snapshot request to the log node, the snapshot request including a list of pages that were either replaced or newly loaded in the cache memory;
wherein the log node processor is configured to send a snapshot response to the database node, wherein the snapshot response includes a snapshot of the database and a list of changed pages of the database instances; and
wherein the database node processor is configured to update the status of the pages in cached memory according to the snapshot response and perform the database transaction.

2. The database system of claim 1,
wherein the database node processor is configured to:
change a page status to semi-valid and assigning a valid log snapshot number (LSN) to the page when loading the page from the persistent storage device; and include a list of pages with the semi-valid page status and the valid LSN of the pages in the snapshot request; wherein the log node processor is configured to:
identify a page as invalid for the database node using a comparison of the page valid LSN to a latest LSN for the page; and include identified invalid pages in the snapshot response.

3. The database system of claim 2, wherein the log node processor is configured to send the valid LSN in the snapshot response.

4. The database system of claim 1, wherein the database node processor is configured to:
change a page status to semi-valid when loading the page from the persistent storage device;
change a page status from semi-valid to invalid if the page is indicated as changed in the list of changed pages; and
change a page status from semi-valid to valid if the page is a newly loaded page and the page is not indicated as changed in the changed page list.

5. The database system of claim 4, wherein the database node processor is configured to:
change a page status from valid or semi-valid to invalid if the page is indicated as changed in the list of changed pages; and
change a page status from invalid to semi-valid when loading the page from the persistent storage device.

6. The database system of claim 1, wherein the log node processor is configured to:
send a record of executed database transactions from the log node to a persistent storage device; and
send the snapshot response when records of database transactions executed prior to the initiated database transaction were sent to the persistent storage device by the log node.

7. The database system of claim 6, wherein the persistent storage device is configured to generate the database snapshot using the record of executed database transactions.

8. The database system of claim 1, wherein the log node memory is configured to store a hash table for cached pages of the database node; and update the hash table in response to the snapshot request.

9. A computer-implemented method of database coherency in a system containing multiple database instances, the method comprising:
initiating a database transaction by sending a snapshot request from a database node to a log node, the snapshot request including a list of pages in a cache memory of the database node that were either replaced or newly loaded;
receiving a snapshot response at the database node from the log node, wherein the snapshot response includes a snapshot of the database and a list of changed pages of the database instances; and
updating the status of the pages in cached memory of the database node according to the snapshot response and performing the database transaction.

10. The method of claim 9, including:
changing, in the database node, a page status to semi-valid and assigning a valid log snapshot number (LSN) to the page when the page is loaded from persistent storage;
including a list of pages with the semi-valid page status and the valid LSN of the pages in the snapshot request; and
receiving, at the database node, identified invalid pages and the valid LSN in the snapshot response.

11. The method of claim 10, including identifying, by the log node, a page as invalid for the database node using a comparison of the page valid LSN to a latest LSN for the page.

12. The method of claim 9, wherein updating status of the pages in cached memory includes:
changing a page status to semi-valid when the page is loaded from persistent storage;
changing a page status from semi-valid to invalid if the page is indicated as changed in the list of changed pages; and
changing a page status from semi-valid to valid if the page is a newly loaded page in the database node and the page is not indicated as changed in the changed page list.

13. The method of claim 12, wherein updating status of the pages in cached memory includes:
changing a page status from valid or semi-valid to invalid if the page is indicated as changed in the list of changed pages; and
changing a page status from invalid to semi-valid when the page is loaded from persistent storage.

14. The method of claim 9, including:
sending a record of database transactions committed prior to the initiated database transaction from the log node to a persistent storage device; and
sending the snapshot response when the record is sent.

15. The method of claim 9, including updating, by the log node, a hash table for cached pages of the database node in response to the snapshot request.

16. The method of claim 9, including storing a database instance of the multiple database instances in the cache memory of the database node, and wherein initiating the database transaction includes a processor of the database node initiating the database transaction.

17. A log node of a database system, the log node comprising:
a memory storage comprising instructions; and
one or more processors in communication with the memory, wherein the one or more processors execute the instructions to:
receive a snapshot request from a database node of the database system, the snapshot request including a list of pages either replaced or newly loaded in cache memory of the database node; and
send a snapshot response to the database node, wherein the snapshot response includes a snapshot of the database and a list of changed pages of the database instances.

18. The log node of claim 17, wherein the one or more processors execute the instructions to:
assign a valid log snapshot number (LSN) to the database transaction;
identify a page as invalid for the database node using a comparison of the page valid LSN to a latest LSN for the page; and
include identified invalid pages in the snapshot response.

19. The log node of claim 17, wherein the one or more processors execute the instructions to:
send a record of executed database transactions from the log node to a persistent storage device; and
send the snapshot response when records of database transactions executed prior to the initiated database transaction were sent to the persistent storage device by the log node.

20. The log node of claim 17, wherein the one or more processors execute the instructions to store a hash table for cached pages of the database node; and update the hash table in response to the snapshot request.
